(19) United States
(12) Patent Application Publication
(10) Pub. No.: US 2021/0027368 A1
(43) Pub. Date: Jan. 28, 2021

(54) INTELLIGENT MULTI-LEG TRANSACTION SYSTEMS AND METHODS

(71) Applicant: REFINITIV US ORGANIZATION LLC, New York, NY (US)

(72) Inventor: Zachary CORDES, Chicago, IL (US)

(73) Assignee: REFINITIV US ORGANIZATION LLC, New York, NY (US)

(21) Appl. No.: 16/932,375

(22) Filed: Jul. 17, 2020

Related U.S. Application Data
(60) Provisional application No. 62/876,964, filed on Jul. 22, 2019.

(51) Int. Cl. G06Q 40/04; G06N 20/00; G06F 40/205; G06F 9/54; G06F 17/18

(52) U.S. Cl. CPC G06Q 40/04; G06N 20/00; G06F 17/18; G06F 9/547; G06F 40/205

(57) ABSTRACT

Computer-readable media, systems and methods may improve performance efficiency of generating custom position data of multi-leg transactions. For example, a system may receive a request to generate a custom multi-leg transaction involving variable ratios that may be evaluated against historical data derived from electronically traded commodities. Responsive to the request, the system may execute a computational workflow that applies rules to parse encoded futures symbols of the multi-leg transaction, build timeseries for historical years based on the input and the historical data and generate a GUI portion that may be transmitted to the user device via the interface. In some examples, the system may use a classifier to identify time intervals that are similar to one another for purposes of a given multi-leg transaction. The classifier may include a rule-based classifier that applies decisioning rules or a machine-learning (ML) classifier that is trained using training datasets.

### RELATED APPLICATIONS

This application claims priority to U.S. Provisional Patent Application No. 62/876,964, filed on Jul. 22, 2019, the content of which is incorporated by reference in its entirety herein.

### BACKGROUND

Electronic trading in commodities and other asset markets have introduced complexity in the different types and combinations of trades that may be executed, complicating the way in which data relating to historical trades are stored, computed, transmitted, and presented over a network. For example, one type of trade may include a multi-leg transaction in which multiple individual contracts are entered into as a single transaction. In some examples, each leg in the multi-leg transaction may represent an individual futures contract that expires at some time in the future. Some of the individual futures contracts in a multi-leg transaction may involve the same commodity but expiring at different times, different commodities expiring at the same or different times, and other combinations of commodities and expiration dates. Each of the individual futures contracts may include a ratio that indicates the position of the multi-leg transaction. For example, the ratio of each individual futures contracts may indicate how much of the individual futures contract is to be bought or sold (where a negative ratio may indicate a short position and a positive ratio may indicate a long position) relative to other ones of the individual futures contract in the multi-leg transaction. Thus, the performance of the multi-leg transaction may depend upon an aggregate of the performance of each individual futures contract and its respective ratio in the multi-leg transaction.

Because of the variable nature in which a multi-leg transaction may be constructed, a single timeseries relating to the performance of a multi-leg transaction may be unavailable, making generation of comparative historical analysis difficult. For example, unlike stock ticker symbols, a futures symbol may depend on an expiration date (month and/or year). Thus, a single continuous historical timeseries may not be available for a given set of two or more futures contracts in the multi-leg transaction. Furthermore, because the multi-leg transaction may be customized to include a combination of variable contracts, historical data for the multi-leg transaction may be unavailable. As such, assessing the performance of such proposals based on historical data may be difficult.

Computing the timeseries and other metrics for a multi-leg transaction may be computationally burdensome. Furthermore, updating such computations to assess new or revised positions over a network may contribute to computational overhead and/or network congestion. These and other problems may result from electronically trading futures commodities over a network.

### SUMMARY

The disclosure relates to systems, methods, and computer-readable media that improve performance efficiency of generating custom position data of multi-leg transactions. In some examples, the system may generate an interface to receive a request that includes input parameters for a custom multi-leg transaction involving variable ratios that may be evaluated against historical data derived from electronically traded commodities. The input parameters may specify one or more futures symbols that each encode an individual contract in a custom multi-leg transaction, a ratio for each individual contract, historical years (or other time interval), and/or other inputs to build a multi-leg transaction to be evaluated against the historical data. An individual contract may refer to a futures contract, an asset purchase or sale, and/or other portion of the multi-leg transaction.

Responsive to the request, the system may execute a computational workflow that applies rules to parse the encoded futures symbols in the multi-leg transaction, builds timeseries for historical years based on the input and the historical data and generate a GUI portion that may be transmitted to the user device via the interface. Each timeseries may represent how the multi-leg transaction would have performed in a respective historical year. The GUI portion may be based on an analytical output based on the timeseries. In some examples, the interface may receive updates to the input to facilitate dynamically-modified multi-leg transactions. In these examples, the computer system may revise the GUI portion based on the updates to the input. Also in these examples, the computer system may re-assess the updated inputs and compute only new data to reduce re-computation and re-transmission of analytical outputs that were previously generated for prior inputs that overlap with the current inputs.

In some examples, the system may use a classifier to identify time intervals that are similar to one another for purposes of a given multi-leg transaction. For example, the classifier may determine which year from among historical years are similar to the current year. In this way, the historical year involving the individual futures contracts may be compared to the current year to assess how the multi-leg position may perform in the current year.

In some examples, the classifier may include a rule-based classifier in which the system may apply decisioning rules that may include conditional logic to determine a similarity metric between different years or other time intervals. In some examples, the classifier may include a machine-learning (ML) classifier that is trained using training datasets to determine the similarity metric between different years or other time intervals.

### BRIEF DESCRIPTION OF THE DRAWINGS

Features of the present disclosure may be illustrated by way of example and not limited in the following Figure(s), in which like numerals indicate like elements, in which:

FIG. 1 illustrates a block diagram of an example of a system of generating position data of custom multi-leg transactions;

FIG. 2 illustrates examples of timeseries and position data of multi-leg transactions, generated by the system illustrated in FIG. 1, for evaluating against an input multi-leg transaction;

FIG. 3A illustrates an example of a rules-based classifier for determining a similarity metric between a current year and one or more historical years;

FIG. 3B illustrates an example of a machine-learning classifier for determining a similarity metric between a current year and one or more historical years;

FIGS. 4A and 4B are flow diagrams that together illustrate of an example of a method of generating position data of custom multi-leg transactions;

FIGS. 5A-5G each respectively illustrate an example of a screenshot of a graphical user interface for presenting timeseries and position data of multi-leg transactions;

FIG. 6 is a flow diagram that illustrates an example of a method of switching between a default and multi-leg spread mode of operation; and

FIG. 7 is a flow diagram that illustrates an example of a method of identifying a time period, such as year, for a leg in a multi-leg transaction.

FIG. 8 is a schematic diagram illustrating an example of mapping expiration years, including years that expire in the future, to an analytical dataset for display.

### DETAILED DESCRIPTION

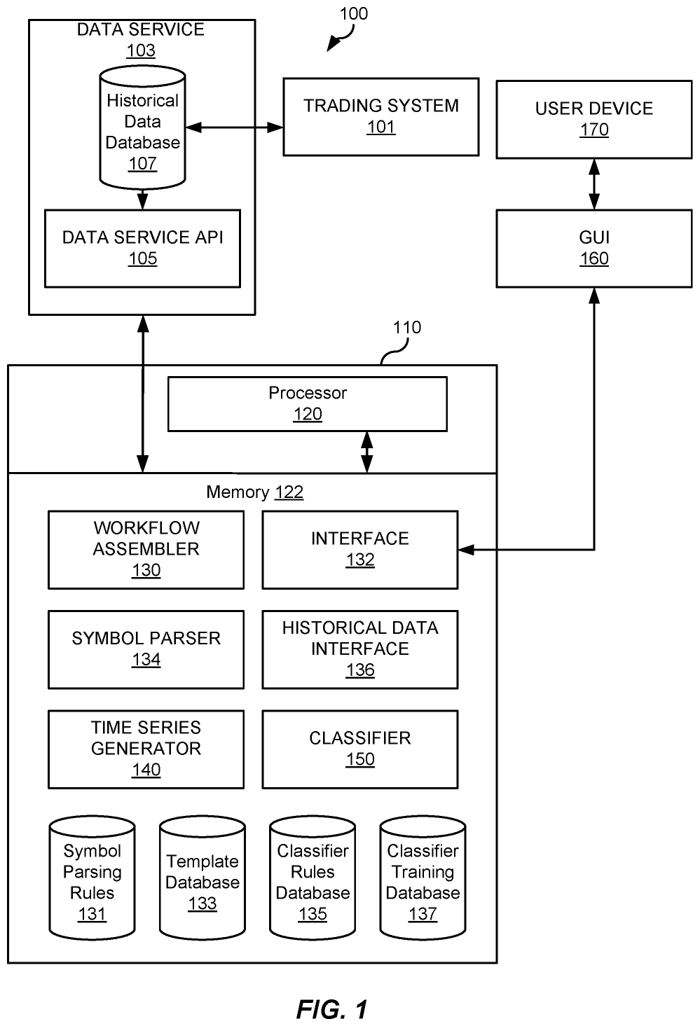

FIG. 1 illustrates a block diagram of an example of a system 100 of generating position data of custom multi-leg transactions. Position data may refer to how an input multi-leg contract would have performed in a historical year, given comparable A multi-leg transaction may refer to a combination of different types of trades executed as a single transaction. For example, a multi-leg transaction may involve calendar spreads, ratios, strips, baskets, and/or other types of trading transactions. A calendar spread is an options or futures spread established by simultaneously entering a long and short position on the same underlying asset at the same strike price but with different delivery months. A ratio calendar spread may refer to a sale of a greater number of near-term options than long term options purchased. A futures strip may refer to the buying or selling of futures contracts in sequential delivery months traded as a single transaction. A basket trade may refer to an order to buy or sell a group of securities simultaneously. Basket trading is essential for institutional investors and investment funds who wish to hold a large number of securities in certain proportions. Various examples described herein will be described in the context of a multi-leg transaction involving futures contracts, although other types of combined transactions may be used.

The system 100 may include a trading system 101, a data service 103, a computer system 110, a user device 170, and/or other components.

In an example, the computer system 110 may receive a request from the user device 170. The request may include one or more input parameters for building and assessing custom positions of multi-leg transactions. The one or more input parameters may include one or more futures symbol, ratio for each of the futures symbol, historical years (or other time interval) for analysis, and/or other parameters. A futures symbol may refer to an encoding that represents an identification of a futures contract. For example, the futures symbol may encode a contract symbol, an expiration month code, and an expiration year code. The contract symbol may represent a type of contract to which the futures contract relates. Non-exhaustive examples of types of contract may include an agriculture futures contract (such as for corn, soybeans, and so forth), a currency futures contract (such as for the U.S. dollar, Australian dollar, and so forth), an energy futures contract (such as for crude oil, natural gas, and so forth), metals futures contracts (such as for gold, silver, and so forth), and/or other types of contracts that may be traded as futures. The contract symbol may include an alphanumeric or other representation. For example, corn may be represented by the letter “C”, the U.S. dollar by the letters “DX”, crude oil by the letters “CL”, and gold by the letters “GC”.

The expiration month code may represent a month in which the futures contract expires. For example, the twelve months of January through December may be respectively represented by the letters “F”, “G”, “H”, “J”, “K”, “M”, “N”, “Q”, “U”, “V”, “X”, and “Z”. The expiration year code may represent a year in which the futures contract expires. The year may be represented by the last one or two digits of the year. For example, 2017 may be represented as “17” and 2020 may be represented as “0”.

The contract symbol, expiration month code, and expiration year code may be combined to generate a futures symbol, such as by concatenating these values in a particular order. For example, a futures contract for gold that expires in December 2017 may be represented by the futures symbol “GCZ17”.

An active futures contract may refer to a futures contract that has not yet expired. The input may further specify a ratio of each of the active futures contracts indicating whether the futures contract is long or short and the relative quantity to be traded with respect to other active futures contracts in the multi-leg transaction. The computer system 110 may build expired futures contracts for each input, identify which instrument expires first, and set start and end dates for an x-axis based off earliest expiration. An expired futures contract may refer to a futures contract that has already expired.

A contract ratio may refer to a number of each futures contract to be transacted relative to other futures contracts specified by the one or more futures symbols. For example, in a proposed multi-leg transaction, futures symbols “1CK0”, “1CN0”, and “1CU0” may be specified as input with respective ratio values +1, −2, and +1. The foregoing may refer to purchasing contracts in the ratios: buy one (+1) corn (“C”) futures contract that expires in May (“K”) 2020 (“0”), sell two (−2) corn futures contracts that expires in July (“N”) 2020, and buy one (+1) corn futures contracts that expires in September (“U”) 2020. It should be noted that while “−” notation may always be included for negative ratio values, the “+” notation for positive ratio values may not be included in some examples, but is shown in the foregoing example for illustration. It should be further noted that the ratio values are not necessarily integer values, but may include decimal values.

The computer system 110 may retrieve historical data from the data server 103 (via a data service Application Programming Interface (API) 105) to generate a timeseries of each futures contract (which may include expired futures contracts) in the historical data, multiply each timeseries by the ratio, and compute a position value for each day. The computer system 110 may normalize years to day of year and consolidate positions values by day-of-year across years. The computer system 110 may then display the values for each year as different lines on the chart. The chart may provide input options such as buttons to select/de-select historical years.

Having described an overview of an example operation of the computer system 110, attention will now turn to further details of the system 100. The trading system 101 may execute electronic trading in commodities and other asset markets over a network. In some examples, the trading system 101 may execute futures trading. Generally, in futures trading, the settlement price of assets covered in a futures contract at the end of each trading day is determined and then profit and loss is settled between the long and the short positions. Such settlement value may be referred to herein as a “daily trade value.” The daily trade value of each contract month is determined separately with market expectations and demand putting significant influence on the further contract months. Thus, for example, a corn futures contract that expires in July may have a different daily trade value than a corn futures contract that expires in September—even on the same day.

The data service 103 may include a service that provides a wide range of data, including historical data based on the trades executed on the trading system 101. One example of the data service 103 may include the EIKON platform by Refinitiv® and Refinitiv® Workspace. The data service 103 may expose data service API 105 that provides access to the historical data database 107. The data service API 105 may include a service that provides historical data for expired futures contracts, such as by querying the historical data database 107 based on the query parameters. For example, the data service API 105 may include a RESTful (REST) Application Programming Interface (API), a Simple Object Access Protocol (SOAP) interface, and/or other type of interface that may provide access to the historical data and/or other data. The data service API 105 may query content using APIs with programming languages such as JAVA, .NET, a dedicated PYTHON extension, and/or other languages.

The computer system 110 may include a server, a computer, or the like that may custom position data of multi-leg transactions. The computer system 110 may include a processor 120, a memory 122, and/or other components. The processor 120 may include a semiconductor-based microprocessor, a central processing unit (CPU), an application specific integrated circuit (ASIC), a field-programmable gate array (FPGA), and/or other suitable hardware device. The memory 122 may have stored thereon machine-readable instructions (which may also be termed computer readable instructions) that program the processor 120 (and therefore computer system 110) to execute various functions described herein with respect to the computer system 110. The memory 122 may be an electronic, magnetic, optical, or other physical storage device that includes or stores executable instructions. The memory 122 may be, for example, Random Access memory (RAM), an Electrically Erasable Programmable Read-Only Memory (EEPROM), a storage device, an optical disc, and the like. The memory may be a non-transitory machine-readable storage medium, where the term “non-transitory” does not encompass transitory propagating signals.

In some examples, the memory 122 may store a workflow assembler 130, a symbol parser 134, a historical data interface 136, a timeseries generator 140, a classifier 150, and/or other instructions. It should be noted that each of the foregoing instructions may be implemented in hardware instead of instructions that program the processor 120.

The workflow assembler 130 may execute a computational workflow to analyze futures contracts against historical data of expired futures contracts. The computational workflow may refer to operations of various computational instructions or operations that are executed by the interface 132, the symbol parser 134, the historical data interface 136, the timeseries generator 140, and/or the classifier 150.

In some examples, the workflow assembler 130 may provide or otherwise be in communication with the interface 132 to receive inputs for analyzing futures contracts in the context of historical data of expired futures contracts. The interface 132 may provide a graphical user interface (GUI) 160 for display at a user device 170. Through the GUI 160, the interface 132 may receive a request to analyze a proposal of one or more futures contracts to assess such proposal against historical data. The proposed futures contracts may include one or more futures symbols and one or more contract ratios (for multi-leg or multi-contract proposals). The proposed futures contract may be compared against one or more historical years to determine how the ratios of the one or more futures symbols will perform based on the comparison to historical data such as expired futures contracts. The request may include one or more futures symbols, one or more ratios, and one or more historical years for comparison.

In some examples, the workflow assembler 130 may use the symbol parser 134 to extract the contract symbol from each of the one or more futures symbols for comparison against historical data associated with the input years. The symbol parser 134 may access and apply symbol parsing rules 131 to parse a futures symbol representing a futures contract. For example, the symbol parsing rules 131 may include logic or instructions applied by the symbol parser 134 to extract, from the futures symbol, a contract symbol, an expiration month code, and an expiration year code. In a particular example, the symbol parsing rules 131 may specify that for a given futures symbol, parse the futures symbol as a string, including: parse first data until an expiration month code is reached, then parse second data in the string after the expiration month code is reached. The parsed first data may correspond to the contract symbol and the parsed second data may correspond to the expiration year code, with the expiration month code in the middle. In some examples, such rules may be encoded as a regular expression. In some examples, such rules may be encoded as a “split” operation in which the string is split into an array based on an expiration month separator.

In some examples, the symbol parser 134 may query historical contract years from that satisfies that contract root (product) and month code (contract month). The foregoing may be facilitated based on contract meta data that may be stored in association with symbols to facilitate identification of historical contract year timeseries

The examples that follows will use the 1CK0, 1CN0, 1CU0 futures symbols as a multi-leg input with respective ratio values of 1, −2, and 1 with input years 2016, 2017, 2018, 2019, and 2020 (as illustrated in FIG. S1). Based on parsing each of the input futures symbols, the workflow assembler 130 may identify the futures contracts associated with each of the input futures symbols. For example, the workflow assembler 130 may determine that the first leg relates to corn futures contracts that expires May 2020 (1CK0), the second leg relates to corn futures contracts that expires July 2020 (1CN0), and the third leg relates to corn futures contracts that expires September 2020 (1CU0).

The workflow assembler 130 may then obtain historical data of corresponding historical (expiring or expired) futures contracts for years specified by the input years (2016, 2017, 2018, 2019, and 2020). In some examples, to gather the historical data, the workflow assembler 130 may invoke (such as call or otherwise use) the historical data interface 136. The historical data interface 136 may access historical data of futures contracts based on query parameters such as a contract symbol, expiration month code, expiration year code, and/or other parameter. For example, the historical data interface 136 may make API calls that include the query parameters through the data service API 105.

For example, for the first leg relating to corn futures contracts that expires May 2020 (1CK0), the workflow assembler 130 may gather historical data for corn futures contracts that expires or expired in May 2016, May 2017, May 2018, May 2019, and May 2020. Likewise, for the second leg relating to corn futures contracts that expires July 2020 (1CN0), the workflow assembler 130 may gather historical data for corn futures contracts that expires or expired in July 2016, July 2017, July 2018, July 2019, and July 2020. Similarly, for the third leg relating to corn futures contracts that expires September 2020 (1CU0), the workflow assembler 130 may gather historical data for corn futures contracts that expires or expired in September 2016, September 2017, September 2018, September 2019, and September 2020.

In some examples, the historical data may include a daily trade close value for each (trading) day in a year. A trade close value may refer to a settlement price of assets covered in a futures contract at the end of each trading day. As would be appreciated, even within the same contract symbol, the trade close value may be different for different futures contracts. For example, for a given trading day, the trade close value for the July 2020 corn futures contract may be different than the trade close value for the September 2020 corn futures contract even though both futures contracts relate to corn. It should be further noted that different legs of the multi-leg transaction may have different contract symbols such as one leg relating to crude oil futures contracts while another leg relates to gasoline futures contracts.

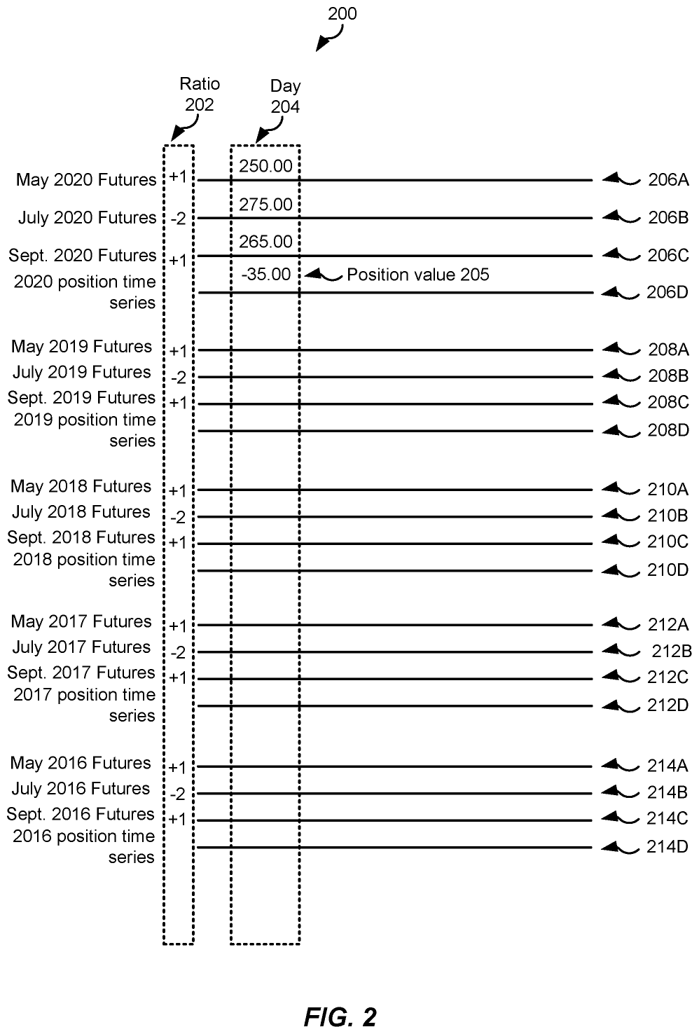

For example, referring to FIG. 2, the workflow assembler 130 may obtain historical data that includes timeseries 206A-C, 208A-C, 210A-C, 212A-C, and 214A-C. In this example, the workflow assembler 130 may generate fifteen timeseries 206A-C, 208A-C, 210A-C, 212A-C, and 214A-C, where each timeseries includes daily trade values for a futures contract in a respective input year.

In some examples, the workflow assembler 130 may generate a position timeseries of values for each input year based on the historical data. Still referring to FIG. 2, for example, the workflow assembler 130 may generate a position timeseries of values 206D based on the timeseries 206A-C. The workflow assembler 130 may likewise generate a position timeseries of values 208D, 210D, 212D, and 214D respectively for each of input years 2019 (based on timeseries 208A-C), 2018 (based on timeseries 210A-C), 2017 (based on timeseries 212A-C), and 2016 (based on timeseries 214A-C). Using each of the position timeseries of values 206D, 208D, 210D, 212D, and 214D, the workflow assembler 130 may generate a chart that includes a line for each position timeseries of values.

To generate the position timeseries of values 206D, 208D, 210D, 212D, and 214D, the workflow assembler 130 may invoke the timeseries generator 140 to normalize the historical data by input year. For example, the timeseries generator 140 may group the timeseries 206A-C respectively corresponding to the May, July, and September 2019 futures contracts. Likewise, the timeseries generator 140 may group the timeseries 208A-C respectively corresponding to the May, July, and September 2019 futures contracts. The timeseries generator 140 may similarly group the remaining timeseries 210A-C, 212A-C, and 214A-C according to respective futures contracts for the remaining input years.

For example, the timeseries generator 140 may align the timeseries in a group according to each trading day corresponding to a respective daily trade value. To illustrate, referring again to FIG. 2, the May 2020, July 2020, and September 2020 futures contracts may be grouped together and their corresponding timeseries 206A-C of daily trade values may be aligned together so that a given daily trade value of timeseries 206A aligns with the daily trade value of timeseries 206B and 206C. In particular, timeseries 206A-C may be aligned so that daily trade values for the settlement date of May 1, 2020 for the May 2020 futures contract aligns with the daily trade value for the settlement date of May 1, 2020 for the July 2020 futures contract and with the daily trade value for the settlement date of May 1, 2020 for the September 2020 futures contract. Each set of timeseries 208A-C, 210A-C, 212A-C and 214A-C for other input years 2016-2019 may be similarly aligned.

In some examples, to align the data, the timeseries generator 140 may count a number of trading days in a respective year and align the days based on the day number. However, doing so may fail to account for holiday and weekend days, thereby resulting in misalignment of the data. In other examples, to align the data, the timeseries generator 140 may provide a more accurate representation of each trading day. In these examples, the timeseries generator 140 may align the data by aligning based on month and day, without the year. Also in these examples, the x-axis may be a normalized representation of the historical timeseries data and therefore not an absolute date axis.

Once the timeseries 206A-C, 208A-C, 212A-C, 212A-C, 214A-C are grouped and aligned, the workflow assembler 130 may compute a position value for each day in the timeseries based on the input ratios and the daily trade value for that day of the input year. A position value for a given trading day may refer to a value that represents how a position based on the input ratios and futures contracts would have performed at the close of the given trading day. For example, still referring to FIG. 2, a particular trading day 204 is described for illustrative purposes. Trading day 204 may refer to a month and date, such as “June 4.” For the particular trading day 204 in a particular year (illustrated in FIG. 2 as the year 2020), the daily trade value may be equal to: 250.00 for the May 2020 futures contract (from timeseries 206A), 275.00 for the July 2020 futures contract (from timeseries 206B), and 265.00 for the September futures contract (from timeseries 206C). In this example, the position value 205 for trading day 204 may be computed as: (250.00*+1)+(275.00*−2)+(265.00*+1)=−35.00. Although not shown, a position value may be similarly computed for each of the other trading days in the timeseries 206A-C to generate the position timeseries of values 206D. Likewise, a position value 205 for each trading day of other sets of timeseries (206A-C, 208A-C, 212A-C, 212A-C, 214A-C) for input years 2016-2019 may be similarly computed to respectively generate position timeseries of values 208D, 210D, 212D, and 214D.

In some examples, the workflow assembler 130 may compile the position values 205 for each trading day in the sets of timeseries 206A-C, 208A-C, 210A-C, 212A-C and 214A-C to generate a timeseries of position values corresponding to each input year. Thus, if five years are input for analysis, five timeseries of position values may be generated. The five timeseries of position values, examples of which may be computed as described above, may represent how the input ratios and futures contracts would have performed in the input years. It should be noted that other numbers of input years, other ratios, and other numbers of futures contracts/legs may be input as well.

In some examples, the workflow assembler 130 may generate an analytical output based on the position timeseries of values 206D, 208D, 210D, 212D and 214D. The analytical output may include a graphical chart, statistical analysis, and/or other data resulting from analyzing the position timeseries of values 206D, 208D, 210D, 212D and 214D.

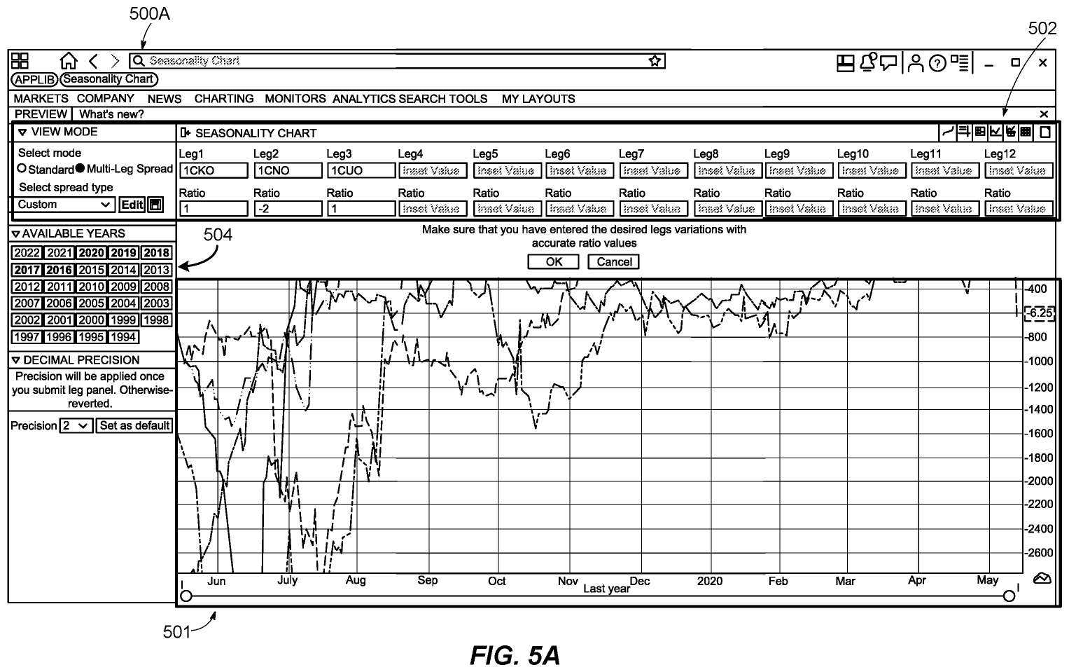

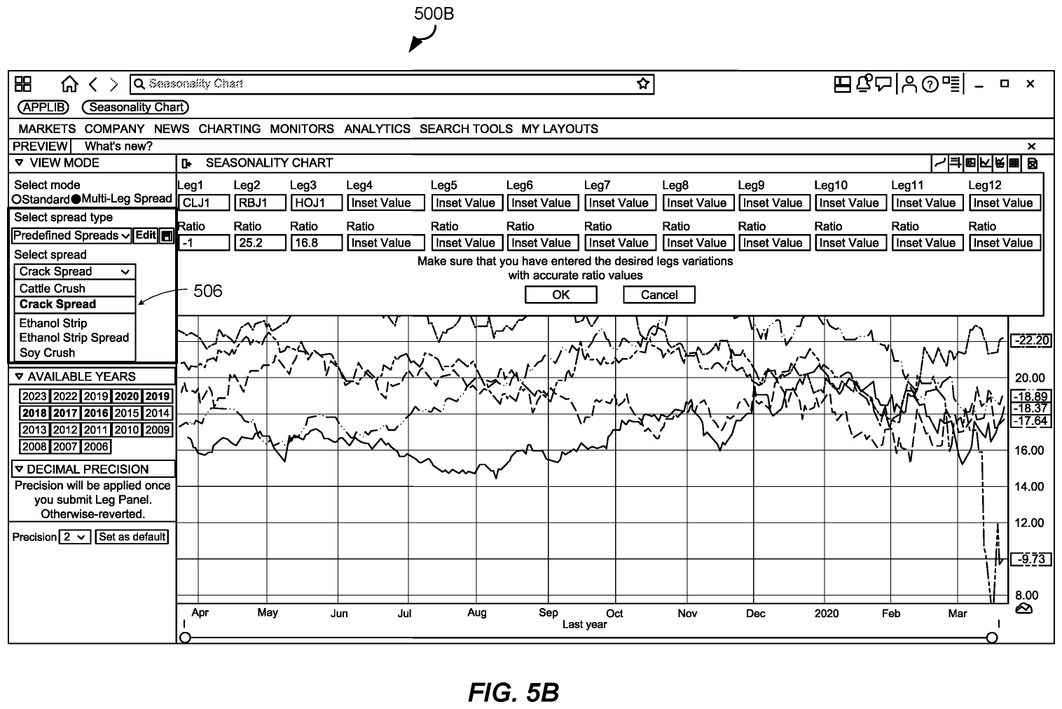

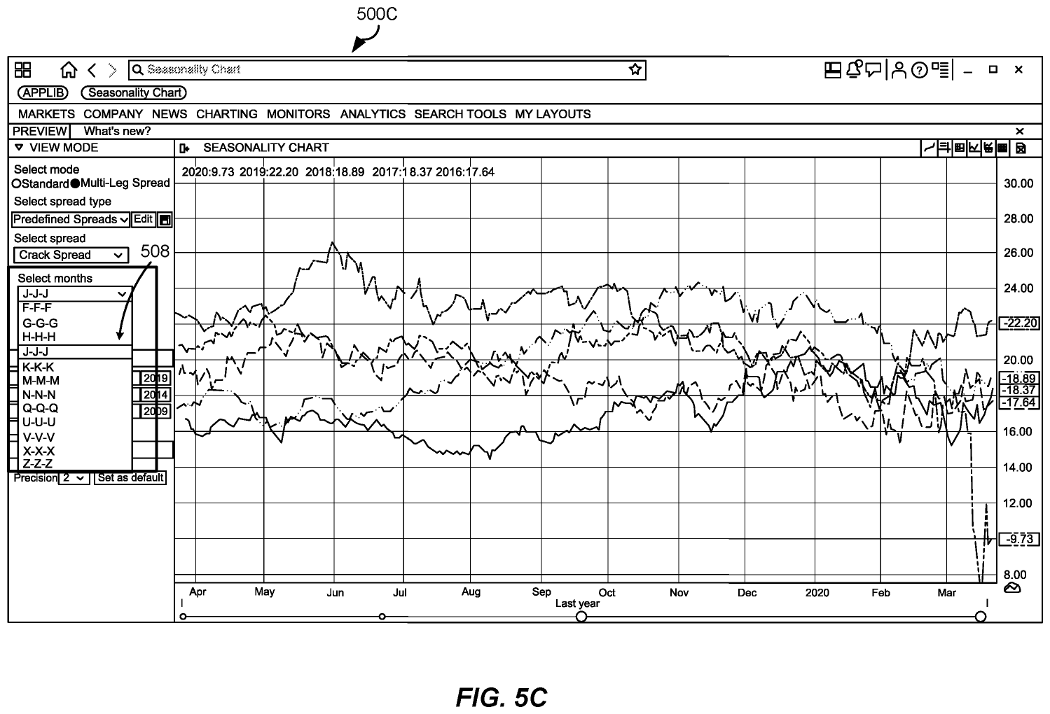

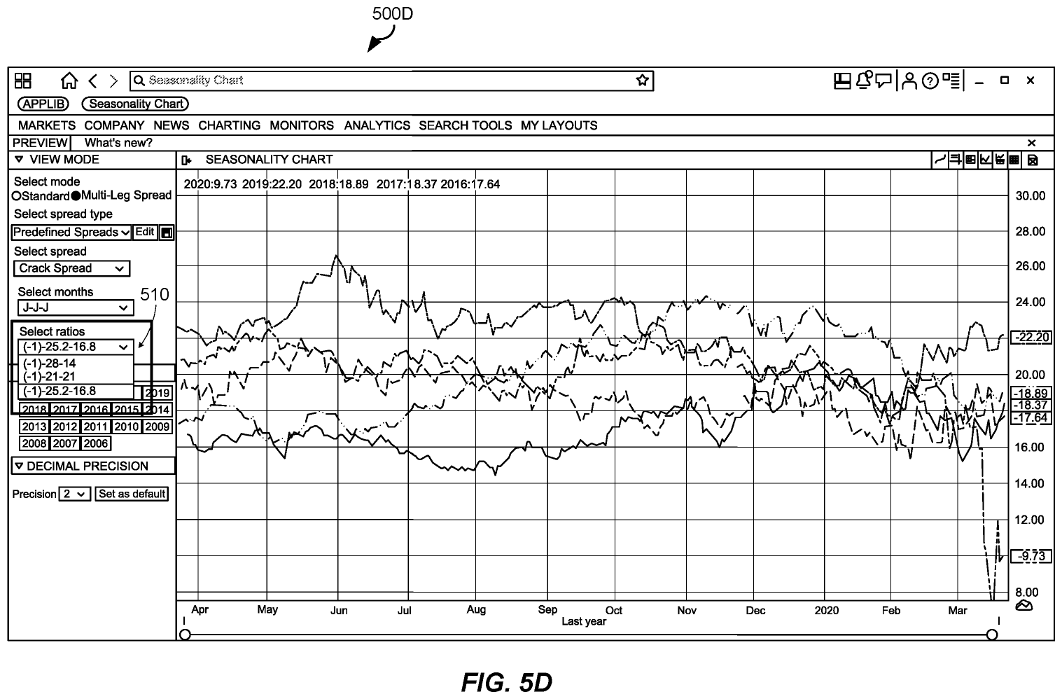

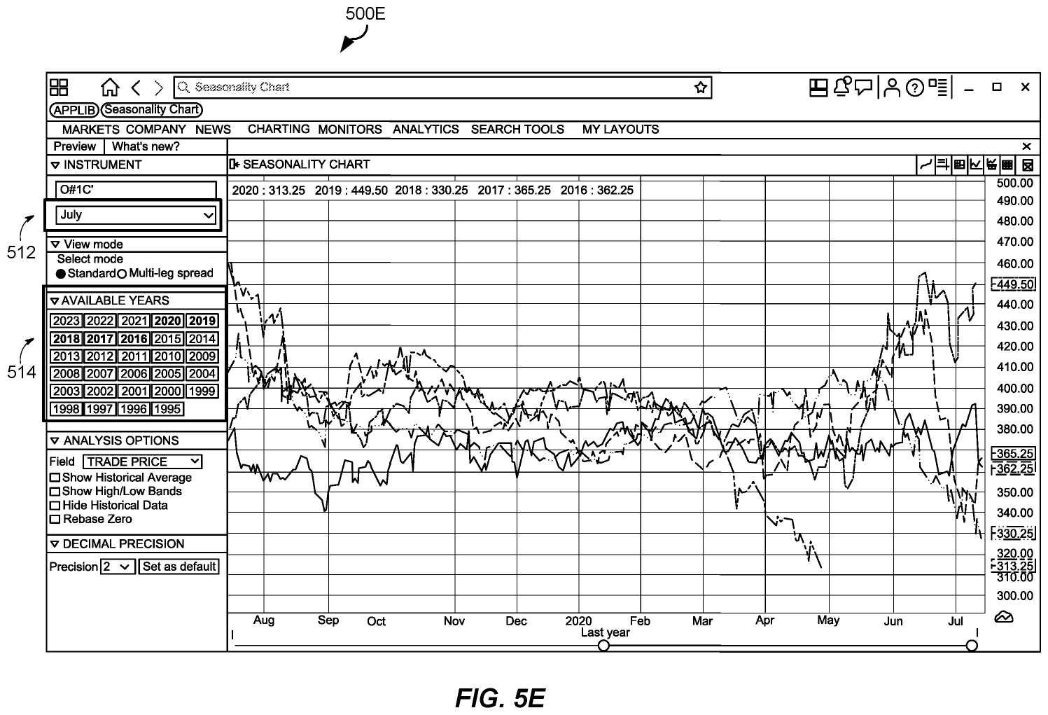

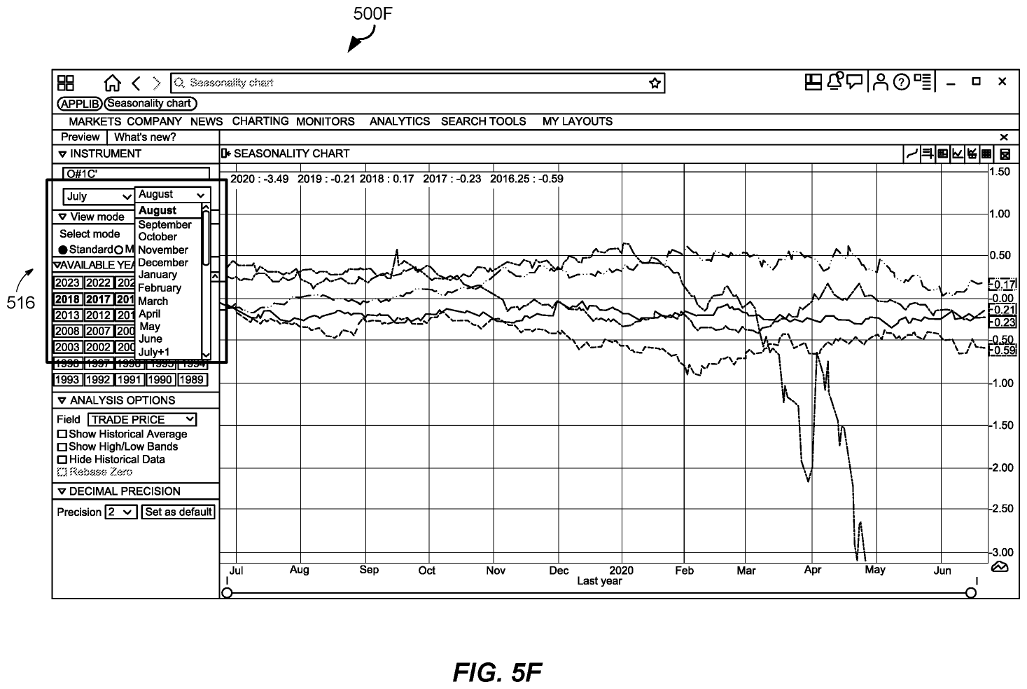

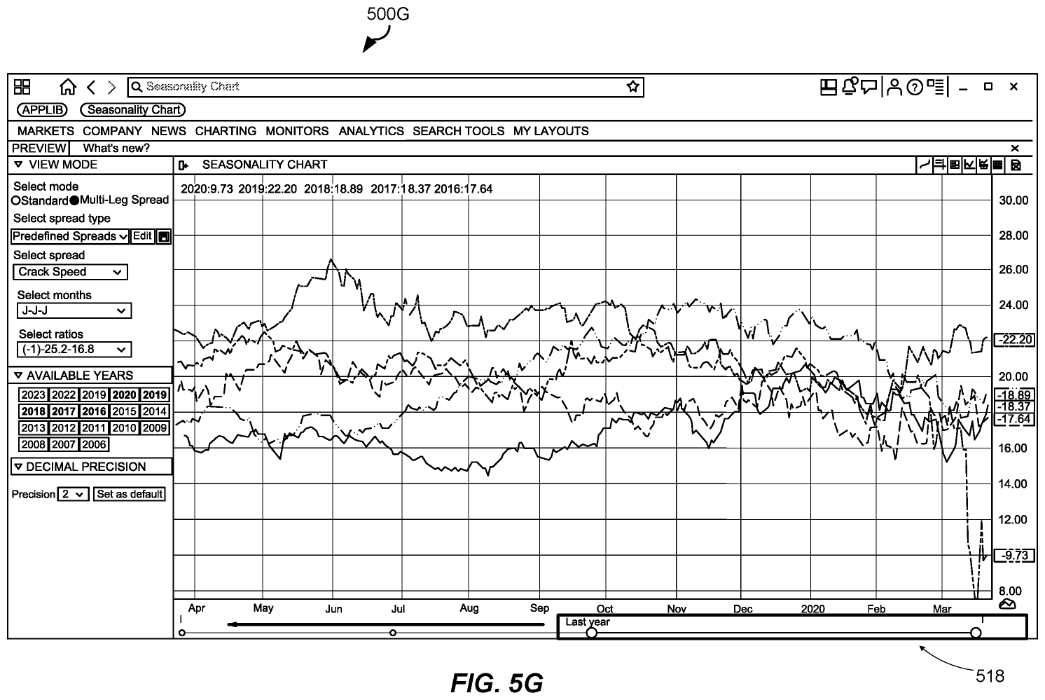

The chart may start at a day corresponding to the earliest of the input futures contract (not counting the year). For example, the May futures contract expiration date may be used to define a starting date and ending date for a one-year chart of the timeseries of position values. Thus, an x-axis of the chart may begin at the May 1 position value and span one year, an example of which is illustrated in FIG. 5A.

In some examples, the workflow assembler 130 may access and apply display rules for adjusting the position timeseries of values 206D, 208D, 210D, 212D and 214D for seasonal display. For example, the display rules may include: (1) the x-axis is set for the seasonal display based on the earliest expiring contract from among the user input; (2) the historical data from all years for that contract is used to determine the latest date the contract expired across years; (3) the latest date from (2) is used to set the x-axis end date; (4) the x-axis beginning date should be one year prior to the end date+one day; (5) the x-axis should allow for further expansion to multiple years; (6) the x-axis for multiple years should provide a display of month-and-day (mm-dd) for additional years beyond the first year; (7) lines representing years on the chart should be drawn in reverse order so that the line representing the most recent year is on top (when to be read left to right); (8) layout and display is to maintain visual appearance with a default chart view (such as a default single year or leg view); (9) the chart is to be placed on a tab, button, or other UI element that changes the default chart view with the custom view presented by the chart; (10) the chart is to interface with search and navigation; (11) display is provide alongside other data such as a table to display statistics for each represented year; (12) interface with other displays through links or other UI element integration.

The statistical analysis may include an analysis of prior years associated with analytical outputs that are similar to the current year's analytical output such as having comparable position timeseries of values, highs, lows, and averages across years, where the current year is trading compared to highs, lows, averages, periods of the year are the most volatile or directional, historical volume in different years, maximum and minimum change from today to expiration, standard deviation, volatility, directionality, and/or other analytics.

In some examples, the workflow assembler 130 may provide the analytical output to the user device 170 via the GUI 160. For example, the workflow assembler 130 may invoke the interface 132 to generate the GUI 160 with the analytical output. Examples of GUI 160 with analytical output that includes charts are illustrated in the screenshots 500A-G respectively shown at FIGS. 5A-G.

In some examples, the computer system 110 may reduce computational overhead and transmission efficiency of customizing the analytical outputs provided by the workflow assembler 130. For example, the computer system 110 may maintain a state of a given session, provide data analysis output for rendering on the user device 170, and/or perform other improved data computation or transmission operations.

Because position timeseries of values for futures contracts may not be stored as a continuous dataset for futures contracts as previously described, such timeseries may be computed on-the-fly based on customizable inputs. The computation may be resource intensive and may require one or more database accesses. Modifications to inputs for generating the time-series may require re-computation of the entire dataset based on the modified inputs, expending computational and additional network bandwidth, as well as potentially multiple database accesses.

To illustrate, via the GUI 160, a user may provide a first input specifying first, second, and third legs, where each leg specifies a futures symbol and ratio. Responsive to the first input, the workflow assembler 130 may access historical data from the historical data database 107 (which may itself require network bandwidth), generate a position timeseries of values based on the historical data as described herein, and generate and provide an analysis output based on the position timeseries of values via the GUI 160. The user may modify or otherwise provide a second input that has at least some parameters that are different than the first input. In this case, the user may analyze different spreads and other changes to the first input to simulate different positions that the user may take. For example, the second input may specify an additional fourth leg, a replacement fourth leg that replaces the third leg, the same first, second, and third legs but with different ratios, and/or other changes. Any changes to the inputs (such as from the first input to the second input) may require repeating the entire access, generate, and transmission cycle for all of the data for the second input and any other subsequent inputs during the given session.

To improve the use of computational overhead and transmission efficiency, instead of re-accessing and re-computing data for a subsequent input, the workflow assembler 130 may update the computations already performed for prior inputs. The foregoing may reduce computational overhead of recomputing the entire analysis output as well as improve network transmission efficiency by generating and transmitting only changes to the resulting analysis output.

In some examples, to update the computations already performed, the workflow assembler 130 may store session data of a given session. The session data may refer to data that is generated or otherwise obtained during a given session. Examples of session data include input from a user (such as the first and second input in the previous example), accessed data, computed data (such as the position timeseries of values), and/or other information relating to the given session. The session data may be stored in various formats, such as in eXtensible Markup Language (XML), Javascript Object Notation (JSON), and/or other types of formats.

A given session may refer to a communication connection in which a user is logged on to the computer system 110 via conventional sign-on techniques such as via user authentication to communicate with the computer system 110. For example, during the given session, the user may be logged on to the interface 132 to communicate the first input and the second input via the GUI 160 to the computer system 110 and/or receive the analysis output from the computer system 110. The communication session may end when the user logs off (such as signs out or is otherwise idle for a predefined period of time). In some examples, the interface 132 may transmit the analysis output via the GUI 160 to the user device 170 via a stateless network protocol, such as the hypertext transfer protocol. In these examples, the workflow assembler 130 may effectively store the state of the given session by storing data accessed and/or computed in a storage cache (not illustrated), which may be temporary or persistent, accessible to the computer system 110. In these examples, the computer system 110 may also mitigate the use of stateless communication protocols when communicating with user devices 170.

In some examples, the workflow assembler 130 may assign a given session with a session identifier, which may uniquely identify the given session. The workflow assembler 130 may store the session data in association with the session identifier so that, for a given session, the session data may be accessed from the session data. For example, when the user inputs the first input specifying first, second, and third legs, contract ratios, and input years, the workflow assembler 130 may store the first input, the historical data, the position timeseries, and/or other accessed or computed data associated with the given session.

When the user inputs the second input, the workflow assembler 130 may compare the second input to previous inputs of the session (such as the first input) and/or of previous sessions that remain in the cache, which may be periodically emptied. Based on the comparison, the workflow assembler 130 may determine any differences between the second input and the previous inputs. In other words, the workflow assembler 130 may determine what, if any, new data is to be accessed and/or computed based on the differences. For example, if the second input adds a fourth leg relative to the first input, the workflow assembler 130 may determine that data relating to the fourth leg is to be accessed and the analysis output is to be updated without re-accessing data relating to the first, second, and third legs.

In some examples, if the data for the fourth leg was already stored in the cache from a prior input, then data relating to the fourth leg may be accessed from the cache. This may occur, for example, when the fourth leg was previously assessed earlier in the same session or during another session. In some examples, the same input may have been provided earlier in the same session or another session. In these examples, a third input from the user may revert back to the first input, in which case the workflow assembler 130 may not re-access or repeat any computation but rather obtain the analytical output from the cache.

In some examples, the second input may remove or add an input year. In this example, the workflow assembler 130 may access data relating to the additional input year, update the analytical output without re-accessing data or re-computing the existing analytical output, and transmit only the updated analytical output. On the other hand, the workflow assembler 130 may remove analytical output for any deleted input year, also without re-accessing data or re-computing the existing analytical output.

Thus, by storing the cache, the workflow assembler 130 may reduce accesses to the historical data database 107, reduce computational overhead in repeating computations, and reduce the quantity of data transmission across a network by providing only updated results.

In some examples, the workflow assembler 130 may generate the chart or other analytical output and provide the chart via GUI 160. Alternatively, or additionally, the workflow assembler 130 may provide the historical data to the user device 170 and instructions executed by an agent of the user device 170 may render the chart and/or other analysis data based on the historical data. In some of these examples, the data may include the timeseries and the instructions may include JavaScript or other instructions executable by the agent, such as a web browser or other application executing at the user device 170. The instructions may cause the agent (and therefore the user device 170) to analyze any changes to the inputs and evaluate the inputs against the data sent to the user device 170. In this manner, some or all of the analysis performed by the workflow assembler 130 may be performed by the user device 170. For example, the user may alter a ratio of the first, second, and third legs and the agent may generate new analytical output based on the new ratio and the data already transmitted to the agent from the computer system 110 without having to transmit a new request to the computer system 110. Likewise, the user may remove an input year and the agent may generate new analytical output based on the removed input year and the data already transmitted to the agent.

In some examples, the updated inputs may require additional data not already transmitted to the agent. For example, the updated inputs may include an added input year (which may require additional data relating to the added input year), a new futures symbol to be analyzed, and/or other inputs that may require additional data. In these examples, the agent may request and the workflow assembler 130 may provide only the new data asynchronously such that an interface or webpage reload—and associated download of the entire dataset for all of the inputs—is not necessary to update the analytical data. For example, the instructions executed at the user device 170 may cause additional data, such as data relating to the fourth leg in the previous examples, to be requested and then analyzed at the user device 170.

The foregoing may improve the process of updating the GUI 160 by reducing or mitigating the requirement of re-computing all of the input data and instead incrementally updating the interface based on changes to the inputs rather than recomputing the entire analysis based on all of the inputs. Thus, the workflow assembler 130 may cause some or all of the computational resources to be expended at the user device 170, reducing network transmission in the event that analyzing the data locally does not require further data from the computer system 110.

In some examples, the workflow assembler 130 may store, in the template database 133, predefined positions. A predefined position may refer to a previously stored set of parameters relating to one or more input futures contracts. For example, a predefined position may include the May, July, and September 2020 corn futures contracts, a ratio for each futures contract, and/or other input parameters. The workflow assembler 130 may provide selectable input options each corresponding to a respective one of the predefined positions to be displayed on the GUI 160 for user selection. The selectable input options may provide the user with an ability to select a predefined position. For example, the GUI 160 may include a selectable input option that, when selected, causes the May, July, and September 2020 corn futures contracts and the corresponding ratios to be input for analysis.

The predefined positions may be determined based on a set of pre-defined positions or most common custom spreads that an industry relating to the futures contracts uses. In these examples, the template of inputs therefore may be provided as selectable options to all users. In some examples, the workflow assembler 130 may save prior inputs of a user for use specifically by that user. In these examples, each user's logon identifier may be stored in association with the inputs of the user for later use. When the user logs onto the computer system 110, the workflow assembler 130 may lookup the prior inputs of the user and present each of one or more of the prior inputs as a respective selectable option.

In some examples, prior to or after providing the analytical output via the GUI 160, the workflow assembler 130 may identify one or more years that are similar to another one or more years. For example, the workflow assembler 130 may identify one or more prior years that are similar to a current year for one or more input futures symbols. In a particular example, for the input futures symbols respectively representing the May, July, and September 2020 corn futures contracts, the workflow assembler 130 may determine that 2017 is most similar to 2020 with respect to the May, July, and September 2020 corn futures contracts. In this manner, the workflow assembler 130 may provide an ability to identify prior years whose position performance is most likely to predict the current year's performance. For example, based on the identification of the 2017 input year, the workflow assembler 130 may predict that the position timeseries of values for the May, July, and September 2017 corn futures contracts may most accurately reflect how the May, July, and September 2020 corn futures contracts will perform. Thus, the workflow assembler 130 may inform the user of the input year that is most similar to the current year and therefore which position timeseries of values will most likely be repeated in the current year. In some examples, the workflow assembler 130 may further automatically execute a set of futures contracts on behalf of the user based on the identification and position (such as by executing a spread for the May, July, and September 2020 corn futures contracts for the input ratio).

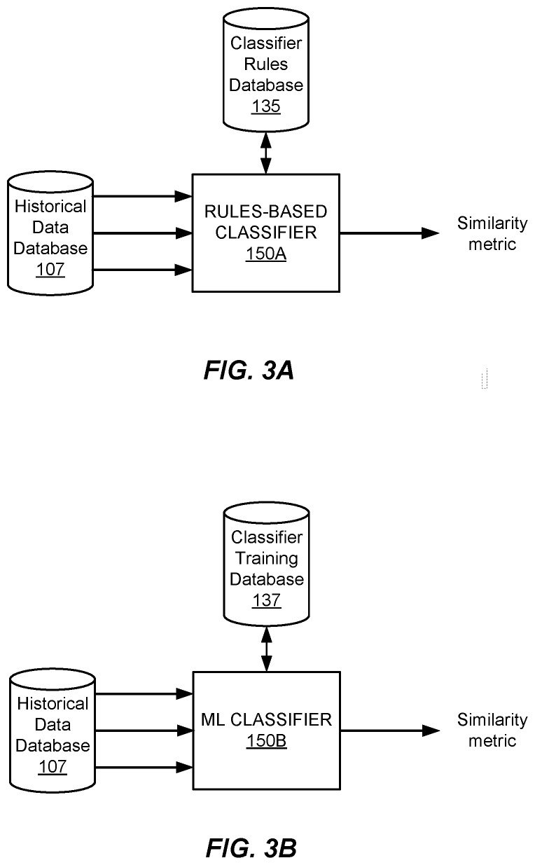

In some examples, to identify one or more prior years similar to the current (or another) year, the workflow assembler 130 may invoke a classifier 150 that generates a similarity metric between at least a first year such as a prior year and a second year, such as the current year, for a given multi-leg transaction. The similarity metric may refer to a determined level of similarity between a given prior year and a current year with respect to the multi-leg transaction in the current year. The classifier 150 may be a rules-based classifier 150A, as illustrated in FIG. 3A, or an Artificial Intelligence (Al), machine-learning (ML) classifier 150B, as illustrated in FIG. 3B.

Referring to FIGS. 1 and 3A, the rules-based classifier 150A may access and apply classification rules stored in the classifier rules database 135. A classification rule may refer to conditional logic applied by the rules-based classifier 150A to determine whether a time interval such as a year is similar to another time interval such as another year with respect to a multi-leg transaction. For example, a classification rule may specify conditional logic that may be used to compare the May 2017 corn futures contract with the May 2020 corn futures contract to determine whether or not the May 2020 corn futures contract will perform similarly to the May 2017 corn futures contract. Examples used herein will refer to a time interval of a year to facilitate year-versus-year comparisons of a multi-leg transaction for illustrative purposes. The time interval may be other time intervals such as months, seasons, and so forth.

A classification rule may be a general classification rule or a specific classification rule. A general classification rule may specify comparisons of features that may be applicable to all types of futures contracts such as agricultural futures, oil/gasoline futures, metal futures, and so forth. For example, a general classification rule may specify comparisons of statistical measurements such as high, low, average, standard deviation, and/or other statistics relating to daily trade close values of various types of futures contracts.

A specific classification rule may specify comparisons of features that may be specific to a type of futures contract. For example, a specific classification rule relating to corn futures contracts may include features affecting agricultural futures daily trade close values such as weather conditions (rainfall, temperature, humidity, and so forth) during a given year or growing season, soil conditions, pest control efforts, irrigation conditions (including municipal, ground water, or other water source conditions), and/or other factors that may affect the harvest or harvest processing. In another example, a specific classification rule relating to oil and gasoline futures contracts may include features such as oil exploration, refinery capabilities, geopolitical events, and/or other factors that may affect oil and/or gasoline output. Other types of features that may impact daily trade close values may be encoded in conditional logic.

In some examples, the classification rules (whether general or specific) may include logic that determines whether or not a prior year is similar to another year based on feature comparisons. For example, a classification rule may specify that the prior year is similar to a current year with respect to a temperature feature if the difference between the average daily temperature for the prior year and the current year is within a predefined threshold. In some examples, the rules-based classifier 150A may assign each feature with a similarity score and aggregate the similarity scores to generate the similarity metric. The rules-based classifier 150A may determine whether a prior year is similar to a current year based on the similarity metric. In some examples, the rules-based classifier 150A may determine a similarity metric for each prior year (based on data from the historical data database 107 for that prior year) relative to the current year and rank the prior years. For example, the rules-based classifier 150A may rank the May 2016 through May 2019 corn futures contracts based on each of their similarities to the current year, as determined from a respective similarity metric. In this manner, the rules-based classifier 150A may identify which ones of the prior years (such as the input years) are most like the current year to determine which of the prior years will likely be most predictive for the current year.

Referring to FIGS. 1 and 3B, the ML classifier 150B may include an autoencoder classifier, a K-Nearest Neighbor (KNN) classifier, and/or other type of classifier that may be trained via ML techniques. Autoencoders may refer to a neural network that may recognize certain patterns from input training data such as the classifier training database 137. An autoencoder may use encoders that decompress the input training data into a lesser dimensional representation of the input. Using decoders, the autoencoder classifier may attempt to recreate the input from the decompressed representation, guided by certain reference points encoded by the encoders. For example, the classifier training database 137 may include features of prior years that may impact daily trade close values. In this example, the autoencoder classifier may be trained to compress the features then decompress the features. Given the input training data, the autoencoder classifier will be able to reproduce the input features. After training, other data (such as for a current year) is input, then the autoencoder classifier may compress the data for the current year, then decompress the data such that a level of difference between the input data and the output data may indicate similarity to the data of the training data. The closer the autoencoder classifier is to recreating the input data, the more similar the current data is to the training data.

To illustrate, an autoencoder classifier may be trained using features that impact daily trade close values of futures contracts. In a specific example, a first autoencoder classifier may be trained on daily temperature values from the year 2017 and/or other features that impact daily trade close values of corn futures contracts. Other features may be used as well. A second autoencoder classifier may be trained on daily temperature values and/or other features from the year 2018. The current year temperature values may be input to the first autoencoder classifier and an output may be generated by the first autoencoder classifier. The input temperature values may be compared to the output to determine whether they diverge, in which more divergence indicates more dissimilarity of the current year temperature values compared to the 2017 temperature values. Thus, based on the level of divergence, the first autoencoder classifier may generate a first similarity metric that indicates a level of similarity between the 2017 temperature values and the current year temperature values. Likewise, the input temperature values may be input to the second autoencoder classifier to generate a second similarity metric that indicates a second level of similarity between the 2018 temperature values and the current year temperature values. The ML classifier 150B may then determine which features of the years 2017 or 2018 are most similar to the features of the current year. For example, based on the output of the ML classifier 1508, the 2017 temperature values may be deemed to be more similar to the current year temperature values than the 2018 temperature values are to the current year temperature values. In this example, the ML classifier 150B may determine that the performance of the May 2017 corn futures contracts may be more predictive of the current year than the May 2017 corn futures contracts. It should be noted that the ML classifier 150B may perform such analysis on multiple years and using multiple legs of a given multi-leg transaction by aggregating similarity metrics of each leg. Other types of classifiers may be trained and used as well.

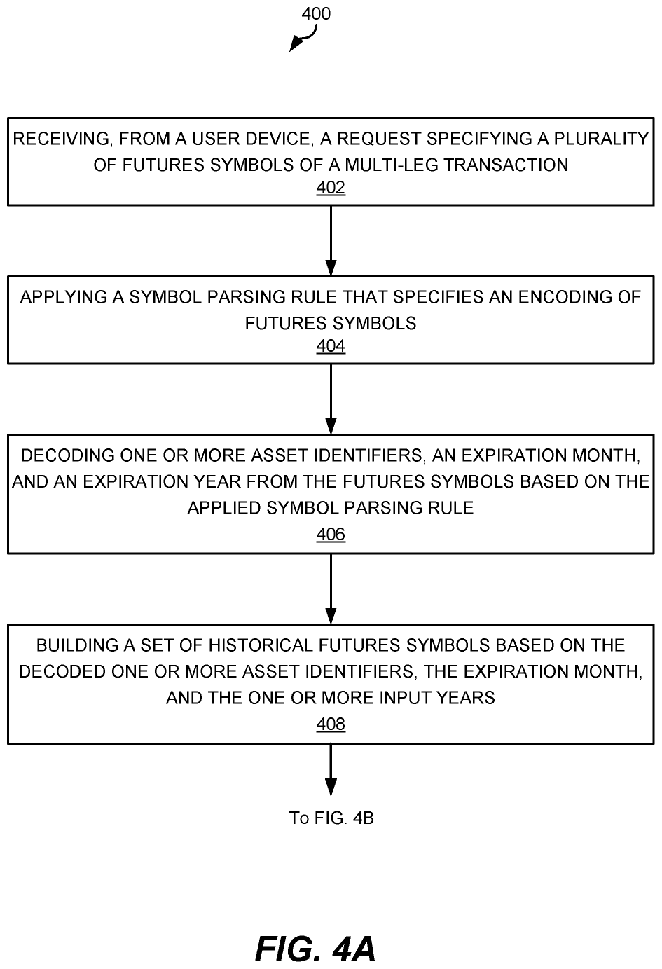

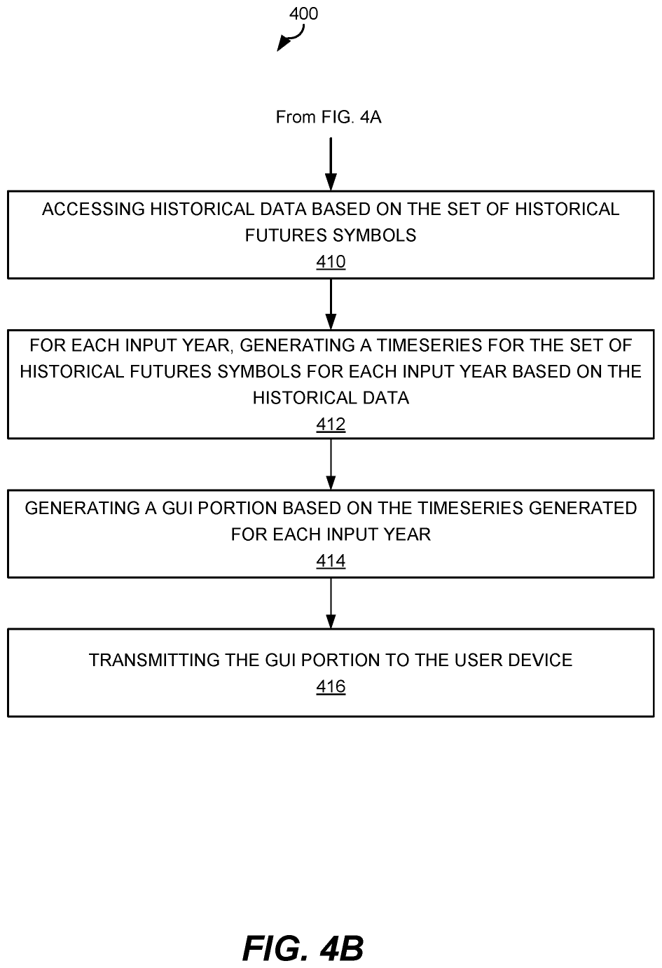

FIGS. 4A and 4B are flow diagrams that together illustrate of an example of a method 400 of generating position data of custom multi-leg transactions. The method 400 may be implemented by a computer, such as the computer system 110.

Referring to FIG. 4A, at 402, the method 400 may include receiving, from a user device, a request specifying a plurality of futures symbols of a multi-leg transaction, a ratio indicating a long or short position for each of the plurality of futures symbols in the multi-leg transaction, and one or more input years to assess how the multi-leg transaction would have performed in the one or more input years, wherein each futures symbol from among the plurality of futures symbols encodes a respective futures contract. In some examples, the request may be formatted according to an XML, JSON and/or other format.

At 404, the method 400 may include applying a symbol parsing rule that specifies an encoding of futures symbols.

At 406, the method 400 may include decoding one or more asset identifiers, an expiration month, and an expiration year from the futures symbols based on the applied symbol parsing rule.

At 408, the method 400 may include building a set of historical futures symbols based on the decoded one or more asset identifiers, the expiration month, and the one or more input years, each historical futures symbol among the set of historical futures symbols encoding a respective expired futures contract.

Referring now to FIG. 4B, at 410, the method 400 may include accessing historical data based on the set of historical futures symbols. In some examples, accessing the historical data may include generating an API call based on each historical futures symbol. The method 400 may include transmitting the API call to a data service (such as data service 103), which may be accessible through the data service API 105. The method 400 may further include receiving the historical data from the data service based on the API call.

At 412, the method 400 may include, for each input year, generating a timeseries for the set of historical futures symbols for each input year based on the historical data (such as timeseries 206A-C, 208A-C, 210A-C, 212A-C, and 214A-C illustrated in FIG. 2).

At 414, the method 400 may include generating a GUI portion based on the timeseries generated for each input year. In some examples, to generate the GUI portion, the method 400 may include, for each input year from among the one or more input years, multiplying each timeseries with a respective ratio of the request, generating a position value (such as a position value 205 illustrated in FIG. 2) for each day in the historical data for the input year, and generating a chart comprising data points based on the position value for each day in the historical data for the input year. For example, the method 400 may include generating position timeseries of values 206D, 208D, 210D, 212D, and 214D illustrated in FIG. 2, and generate a chart based on these position timeseries of values as illustrated in FIGS. 5A-5G. In some examples, to generate the GUI portion, the method 400 may include generating a set of statistical analysis including standard deviation, high, low, and average daily trade close values, value-at-risk (VaR), volatility, and/or other statistics based on the historical data.

In some examples, to generate the GUI portion, the method 400 may include providing a response to the request, such as by providing formatted data (using, for example, XML, JSON, and/or other formats) corresponding to the position value for each day in the historical data for the input year to an agent operating at the user device, the agent rendering the GUI based on the data.

At 416, the method 400 may include transmitting the GUI portion to the user device.

In some examples, the method 400 may further include receiving a second request comprising an update to the input, identifying new data to be analyzed based on the first request and the second request, and provide only new data to the user device. In this manner, the entire dataset need not be transmitted to the user device, reducing computational use and/or network bandwidth than if the entire dataset was recomputed and transmitted to the user device.

In some examples, the method may include accessing one or templates each specifying a predefined transaction comprising one or more futures contracts and a ratio of each of the one or more futures contracts for the predefined transaction, providing the one or more templates to the user device. In some examples, the one or more templates may include general templates generated based on a predefined set of commonly used transactions. In some examples, the one or more templates may include user-specific templates generated based on a session log that stores previous input from a user and are specifically provided to the user when the user is logged on.

In some examples, the method 400 may include receiving a selection of a first template that specifies the plurality of futures symbols and the ratio indicating a long or short position for each of the plurality of futures symbols.

In some examples, the method 400 may further include determining, based on a rules-based classifier (such as the rules-based classifier 150A), a level of similarity of historical years to a current year with respect to the plurality of futures symbols. In some examples, the method 400 may further include determining, based on a machine-learning (ML) classifier (such as the ML classifier 150B), a level of similarity of historical years to a current year with respect to the plurality of futures symbols.

FIGS. 5A-G each respectively illustrate an example of a screenshot 500A-G of a graphical user interface 160 for presenting timeseries and position data of multi-leg transactions.

Referring to FIG. 5A, the GUI 160 illustrated by screenshot 500A may include a GUI portion 501, an input option 502, an input option 504, and/or other portions. The input option 502 may include an input to receive multiple legs, ratio for each leg, and/or other data. The input option 504 may include an input to receive input years or other time intervals for comparison. Each leg may specify, for example, a futures contract and ratio for the futures contract that the user inputs. The inputs via the input options 502, 504 may be transmitted to the computer system 110, which may generate the GUI portion 501. In some examples, the GUI portion 501 may include a chart of position timeseries of values (such as the position timeseries of values 206D, 208D, 210D, 212D, and 214D illustrated in FIG. 2). Each line in the chart may represent a respective year corresponding to each position timeseries of values.

Referring to FIG. 5B, the GUI 160 illustrated by screenshot 500B may include an input option 506, which may provide predefined selectable options based on data from template database 133. For example, the selectable options may be based on templates spreads for easy access to common spreads and provides starting point for customization of spread analysis to user specific needs.

Referring to FIGS. 5C-F, the GUI 160 may provide preconfigured selectable input options such as an input option 508 (FIG. 5C) to provide pre-configured common contract month pairs, an input option 510 (FIG. 5D) to provide pre-configured common ratios for easy access to different market conventions, an input option 512 (FIG. 5E) to change contract expiration months and an input option 514 to change contract years, and an input option 516 (FIG. 5F) to provide spread legs for exchange traded spreads. Referring to FIG. 5G, the GUI 160 illustrated by screenshot 500G may provide an ability to compare contract across years with more than one year of history on the x-axis and slider functionality at input option 518 to simply and intuitively add years.

In various examples, the GUI portion 501 (such as a chart illustrated in FIG. 5A and shown but not labelled in FIGS. 5B-G) may be dynamically adjusted based on revisions to inputs at input options 504, 506, 508, 510, 512, 514, 516, 518, and/or other input options. For example, if the input year “2017” is deselected, then the GUI 160 may transmit the updated inputs to the computer system 110. Instead of recomputing the entire dataset (such as for input years 2016, and 2018-2020), the computer system 110 may remove the position timeseries of values corresponding to the input year 2017, regenerate the GUI portion 501 without the removed position timeseries of values while retaining the other the position timeseries of values, and transmit the regenerated GUI portion 501 via the GUI 160. Similarly, if a new input year “2015” is added, the computer system 110 may generate the position timeseries of values corresponding to the input year 2015, regenerate the GUI portion 501 based on the newly generated the position timeseries of values, and transmit the regenerated GUI portion 501. In other examples, the regenerated data itself (not in chart form, for example), may be transmitted to the user device and the user device may generate the chart locally based on the regenerated data.

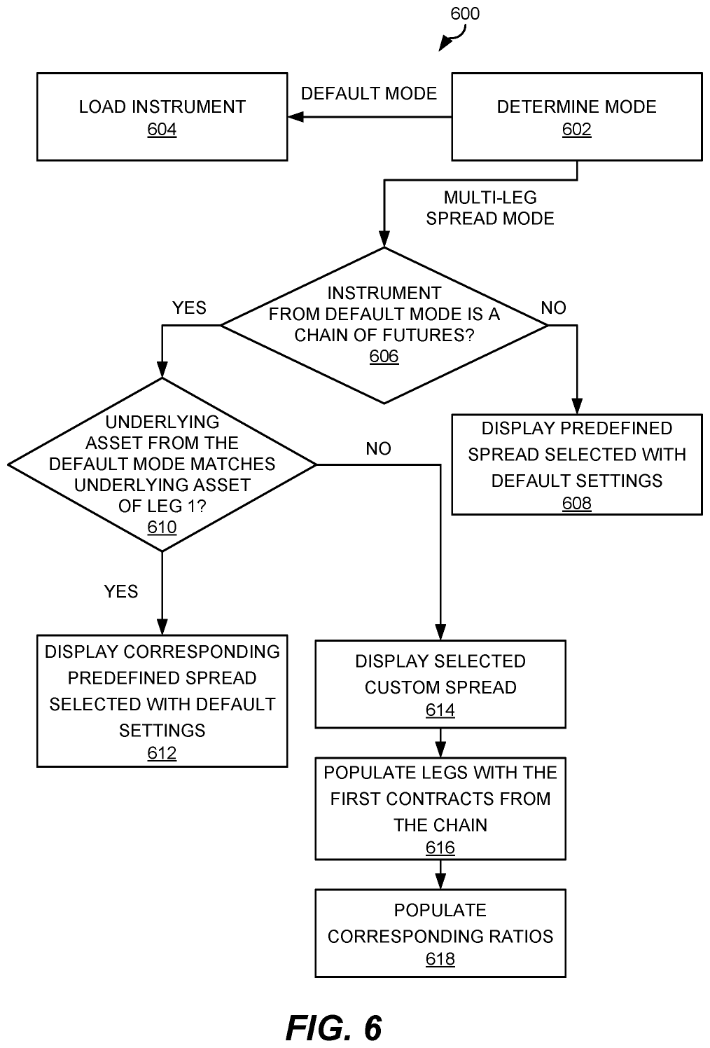

FIG. 6 is a flow diagram that illustrates an example of a method 600 of switching between a default and multi-leg spread mode of operation. At 602, the method 600 may include determining a mode of operation. The mode of operation may refer to a mode in which historical data is analyzed and/or displayed. For example, a default mode of operation may display pre-existing exchange data for a future or spread. A multi-leg spread mode may provide the user customization of existing exchange spreads or creation of user defined spreads or multi leg strategies or portfolios.

In a default mode, at 604, the method 600 may include loading an instrument associated with a single transaction. In some examples, the default mode may include accessing historical data, such as daily trade values, for the instrument and displaying the historical data (such as via a GUI).

In a multi-leg spread mode (such as when switching from a default mode to the multi-leg spread mode), at 606, the method 600 may include determining whether an instrument from the default mode is a chain of futures contracts (a multi-leg transaction). If yes, at 610, the method 600 may include determining whether an underlying asset for the contract from the default mode matches an underlying asset of a contract of leg 1 in the chain of futures. If yes, at 612, the method 600 may include displaying a corresponding predefined spread with default settings. If no, at 614, the method 600 may include displaying a selected custom spread. To do so, at 616, the method 600 may include populating the legs with the first set of contracts (such as 1CK0″, “1CN0”, and “1CU0” in the previous examples described herein) in the chain. At 618, the method 600 may include populating the corresponding input ratios.

Returning to 606, if the instrument from the default mode is a futures (and not a chain of futures) contract, at 608, the method 600 may include displaying a predefined spread with default settings.

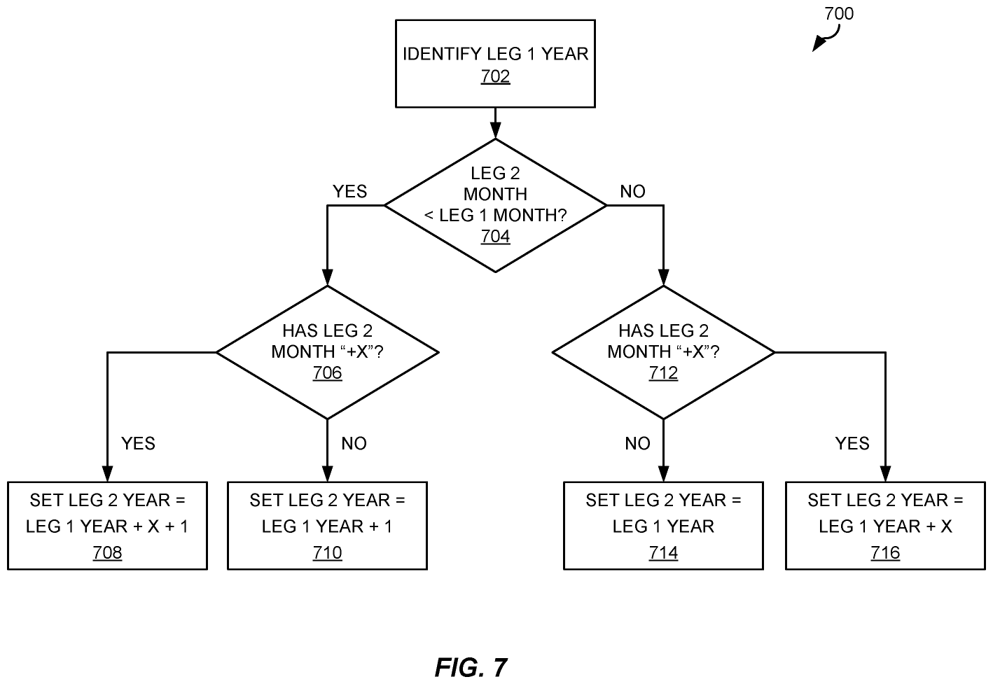

FIG. 7 is a flow diagram that illustrates an example of a method 700 of identifying a time period, such as year, for a leg in a multi-leg transaction. At 702, the method 700 may include identifying a leg 1 year. The leg 1 year may refer to the expiration year of a first leg of a multi-leg transaction specified by user inputs to build the multi-leg transaction. At 704, the method 700 may include determining whether the leg 2 month is less than (before) the leg 1 month. The leg 2 month may refer to an expiration month of a second leg in the multi-leg transaction. Likewise, the leg 1 month may refer to an expiration month of the first leg in the multi-leg transaction. An example of a leg 2 month being less than a leg 1 month is where the leg 2 month is June and the leg 1 month is November.

If the leg 2 month is less than the leg 1 month, then the contract of the second leg associated with the leg 2 month will expire in a future year after the contract of the first leg associated with the leg 1 month. At 706, the method 700 may include determining whether the leg 2 month is associated with a year adjustment (illustrated as “+X”). If so, at 708, the method 700 may include setting the leg 2 year as the leg 1 year+X+1. The leg 2 year may refer to a year in which the second contract associated with the leg 2 month expires. If not, at 710, the method 700 may include setting the leg 2 year as the leg 1 year+1.

Returning to 704, if the leg 2 month is not less than the leg 1 month, at 712, the method 700 may include determining whether the leg 2 month is associated with a year adjustment (“+X”) similar to the year adjustment described at 706. If so, at 714, the method 700 may include setting the leg 2 year equal to the leg 1 year. Otherwise, at 716, the method 700 may include setting the leg 2 year equal to the leg 1 year+X.

It should be understood that the methods 400, 600, and 700 illustrated in FIGS. 4A, 4B, 6, and 7 may include additional operations and that some of the operations described therein may be removed and/or modified without departing from the scope of the methods 400, 600, and 700. The description of the methods 400, 600, and 700 may be made with reference to the features depicted in other figures for purposes of illustration. Some or all of the operations set forth in the methods 400, 600, and 700 may be performed by one or more of the components illustrated in FIG. 1. As such, some or all of the operations set forth in the methods 400, 600, and 700 may be included as circuitry, utilities, programs, or subprograms, in any desired computer accessible medium. In addition, the method may be embodied by computer programs, which may exist in a variety of forms. For example, some operations of each of the methods 400, 600, and 700 may exist as computer-readable instructions, including source code, object code, executable code or other formats.

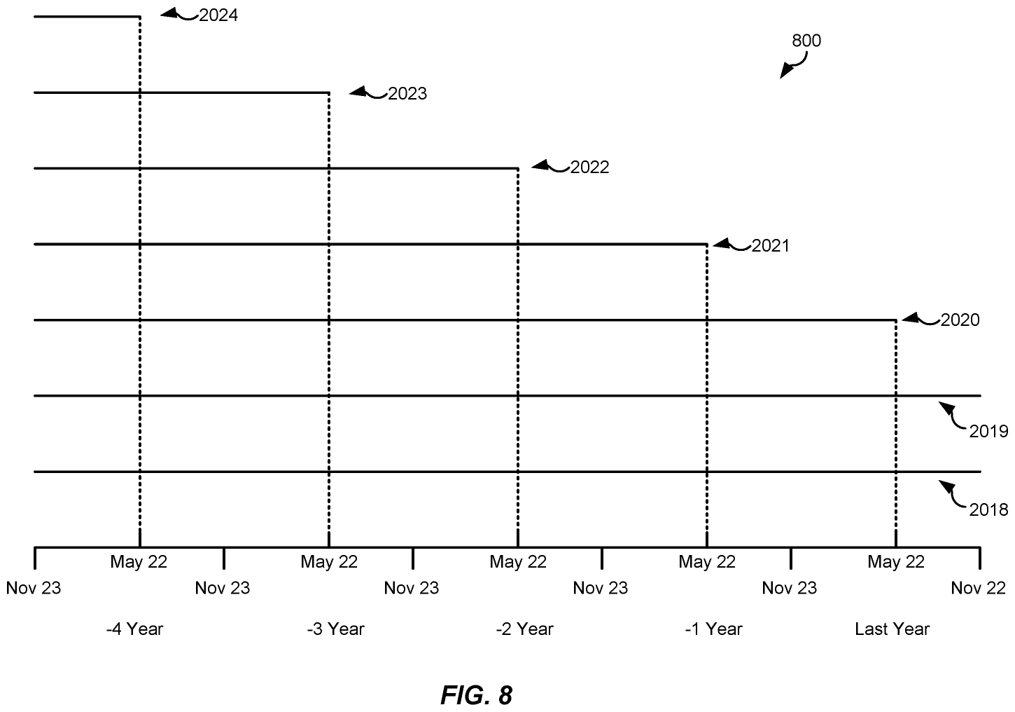

FIG. 8 is a schematic diagram 800 illustrating an example of mapping expiration years, including years that expire in the future, to an analytical dataset for display. The x-axis shows a month and date (such as November 22 or 23 and May 22) and a year (such as “Last Year”, “−1 Year”, “−2 Year”, “−3 Year”, and “−4 Year”). Other year regions may be used as well. Line 2024 represents a contract that will expire in a future year, 2024 (assuming a present year 2020). Line 2023 represents a contract that will expire in a future year, 2023; line 2022 represents a contract that will expire in a future year, 2022; line 2021 represents a contract that will expire in a future year, 2021; line 2020 represents a contract that will expire in a current year, 2020; line 2019 represents a contract that expired in a previous year, 2019; and line 2018 represents a contract that expired in a previous year, 2019. As shown, contracts that will expire in a future year is to be displayed along an x-axis in a region of the x-axis corresponding to the number of years in the future that the contract will expire. For example, contracts expiring in the year 2024 (four years from a current year in the example illustrated in FIG. 8) will be displayed in the −4 Year region. Expired contracts will be displayed through the “Last Year”, which represents the most current year's data that already passed.

In some examples, given GUI (such as a GUI illustrated in FIGS. 5A-G) may not be displayed all at once due to processing or other limitations on a client display and/or processing or other limitations of the workflow assembler 130. Thus, to display time series data for future years, a user may adjust a slider (such as input option 518 illustrated in FIG. 5G) having a slider state to show desired regions of the display. A slider may refer to a GUI control that may be used to adjust the slider state. The slider state may refer to a control that dictates what region is displayed in the GUI. For example, the slider state may include a 0 state in which the Last Year region is displayed, a −4 state in which the −4 Year region is displayed, a −3 state in which the −3 Year region is displayed and so on.

In some examples, a user may dynamically add and/or remove contracts from the GUI. Such addition and/or removal may impact the slider state and/or visibility of timeseries data depending on when their underlying contracts expire. To handle such dynamic updates, the interface 132 may access and apply rules for adjusting the behavior of the GUI responsive to additions and/or removals of contracts (and therefore contract expiration years). The interface 132 may apply the rules by updating the GUI and transmitting the regenerated GUI to the user device 170 for display or may provide instructions and/or data to the user device 170 to update the GUI.

To illustrate, if a user adds a contract that expires in a year that fits within the current display (such as chart) in the GUI, then the slider state may not be adjusted and the timeseries data for that contract may be inserted into the current display. If the user adds a contract that expires in a year that does not fit within the current display, then the slider state may be adjusted to account for the new expiration year (such as by adjusting what year regions are shown).

If the user removes a contract, then the slider state may remain unchanged and the timeseries data (such as line in the chart) is removed. In examples that provide a corresponding data table along with the chart, the data tables may be correspondingly updated.

The various components illustrated in the Figures may be coupled to at least one other component via a network, which may include any one or more of, for instance, the Internet, an intranet, a PAN (Personal Area Network), a LAN (Local Area Network), a WAN (Wide Area Network), a SAN (Storage Area Network), a MAN (Metropolitan Area Network), a wireless network, a cellular communications network, a Public Switched Telephone Network, and/or other network. In FIG. 1, as well as in other drawing Figures, different numbers of entities than those depicted may be used. Furthermore, according to various implementations, the components described herein may be implemented in hardware and/or software that configure hardware.

The various interfaces illustrated in FIGS. 5A-G are shown for illustrative purposes. The appearance or configuration of the interfaces may be altered according to particular needs.

For simplicity and illustrative purposes, the disclosure included descriptions that may refer to examples. In the description, numerous specific details have been set forth in order to provide a thorough understanding of the present disclosure. It will be readily apparent however, that the disclosure may be practiced without limitation to these specific details. In other instances, some methods and structures have not been described in detail so as not to unnecessarily obscure the present disclosure.

Throughout the disclosure, the term “a” and “an” may be intended to denote at least one of a particular element. As used herein, the term “includes” means includes but not limited to, the term “including” means including but not limited to. The term “based on” means based at least in part on.

Although described specifically throughout the entirety of the instant disclosure, representative examples of the present disclosure have utility over a wide range of applications, and the above discussion is not intended and should not be construed to be limiting, but is offered as an illustrative discussion of aspects of the disclosure. What has been described and illustrated herein is an example of the disclosure along with some of its variations. The terms, descriptions and figures used herein are set forth by way of illustration only and are not meant as limitations. As such, the disclosure is intended to be defined by the following claims—and their equivalents—in which all terms are meant in their broadest reasonable sense unless otherwise indicated.

What is claimed is:

1. A computer system to improve customization of spread contracts, the computer system comprising:
a processor programmed to:
receive, from a user device, a request specifying a plurality of futures symbols of a multi-leg transaction, a ratio indicating a long or short position for each of the plurality of futures symbols in the multi-leg transaction, and one or more input years to assess how the multi-leg transaction would have performed in the one or more input years, wherein each futures symbol from among the plurality of futures symbols encodes a respective futures contract;
apply a symbol parsing rule that specifies an encoding of futures symbols;
decode one or more asset identifiers, an expiration month, and an expiration year from the futures symbols based on the applied symbol parsing rule;
build a set of historical futures symbols based on the decoded one or more asset identifiers, the expiration month, and the one or more input years, each historical futures symbol among the set of historical futures symbols encoding a respective expired futures contract;
access historical data based on the set of historical futures symbols;
for each input year, generate a timeseries for the set of historical futures symbols for each input year based on the historical data;
generate a graphical user interface (GUI) portion based on the timeseries generated for each input year; and
transmit the GUI portion to the user device.

2. The computer system of claim 1, wherein to generate the GUI portion, the processor is further programmed to:
for each input year from among the one or more input years:
multiply each timeseries with a respective ratio of the request;
generate a position value for each day in the historical data for the input year; and
generate a chart comprising data points based on the position value for each day in the historical data for the input year.

3. The computer system of claim 1, wherein to access the historical data, the processor is further programmed to:
generate an Application Programming Interface (API) call based on each historical futures symbol;
transmit the API call to a data service; and
receive the historical data from the data service based on the API call.

4. The computer system of claim 1, wherein the processor is further programmed to:
access one or templates each specifying a predefined transaction comprising one or more futures contracts and a ratio of each of the one or more futures contracts for the predefined transaction;
provide the one or more templates to the user device; and
wherein to receive the request, the processor is programmed to receive a selection of a first template that specifies the plurality of futures symbols and the ratio indicating a long or short position for each of the plurality of futures symbols.

5. The computer system of claim 4, wherein the one or more templates comprise general templates generated based on a predefined set of commonly used transactions.

6. The computer system of claim 4, wherein the one or more templates comprise user-specific templates generated based on a session log that stores previous input from a user and are specifically provided to the user when the user is logged on.

7. The computer system of claim 1, wherein to generate the GUI portion, the processor is further programmed to:
generate a set of statistical analysis including high, low, and average daily trade close values based on the timeseries.

8. The computer system of claim 1, wherein to generate the GUI portion, the processor is further programmed to:
provide formatted data corresponding to a position value for each day in the historical data for the one or more input years to an agent operating at the user device, the agent rendering the GUI based on the formatted data.

9. The computer system of claim 8, wherein the processor is further programmed to:
receive a second request comprising an update to the request;
identify new data to be analyzed based on the request and the second request; and
provide only the new data to the user device.

10. The computer system of claim 1, wherein the processor is further programmed to:
determine, based on a machine-learning (ML) classifier, a level of similarity of historical years to a current year with respect to the plurality of futures symbols.

11. The computer system of claim 1, wherein the processor is further programmed to:
determine, based on a rules-based classifier, a level of similarity of historical years to a current year with respect to the plurality of futures symbols.

12. A method, comprising:
receiving, by a processor, from a user device, a request specifying a plurality of futures symbols of a multi-leg transaction, a ratio indicating a long or short position for each of the plurality of futures symbols in the multi-leg transaction, and one or more input years to assess how the multi-leg transaction would have performed in the one or more input years, wherein each futures symbol from among the plurality of futures symbols encodes a respective futures contract;
applying, by the processor, a symbol parsing rule that specifies an encoding of futures symbols;
decoding, by the processor, one or more asset identifiers, an expiration month, and an expiration year from the futures symbols based on the applied symbol parsing rule;
building, by the processor, a set of historical futures symbols based on the decoded one or more asset identifiers, the expiration month, and the one or more input years, each historical futures symbol among the set of historical futures symbols encoding a respective expired futures contract;
accessing, by the processor, historical data based on the set of historical futures symbols;
for each input year, generating, by the processor, a timeseries for the set of historical futures symbols for each input year based on the historical data;
generating, by the processor, a graphical user interface (GUI) portion based on the timeseries generated for each input year; and
transmitting, by the processor, the GUI portion to the user device.

13. The method of claim 12, wherein generating the GUI portion comprises:
for each input year from among the one or more input years:
multiplying each timeseries with a respective ratio of the request;
generating a position value for each day in the historical data for the one or more input years; and
generating a chart comprising data points based on the position value for each day in the historical data for the input year.

14. The method of claim 12, wherein accessing the historical data comprises:
generating an Application Programming Interface (API) call based on each historical futures symbol;
transmitting the API call to a data service; and
receiving the historical data from the data service based on the API call.

15. The method of claim 12, further comprising:
accessing one or templates each specifying a predefined transaction comprising one or more futures contracts and a ratio of each of the one or more futures contracts for the predefined transaction;
providing the one or more templates to the user device; and
wherein to receiving the request comprises receiving a selection of a first template that specifies the plurality of futures symbols and the ratio indicating a long or short position for each of the plurality of futures symbols.

16. The method of claim 12, wherein generating the GUI portion comprises:
generating a set of statistical analysis including high, low, and average daily trade close values based on the timeseries.

17. The method of claim 12, wherein generating the GUI portion comprises:
providing formatted data corresponding to the position value for each day in the historical data for the one or more input years to an agent operating at the user device, the agent rendering the GUI based on the formatted data.

18. The method of claim 17, further comprising:
receiving a second request comprising an update to the input;
identifying new data to be analyzed based on the request and the second request; and
providing the new data to the user device.

19. The method of claim 12, further comprising:
determining, based on a machine-learning (ML) classifier, a level of similarity of historical years to a current year with respect to the plurality of futures symbols.

20. The method of claim 12, further comprising:
determining, based on a rules-based classifier, a level of similarity of historical years to a current year with respect to the plurality of futures symbols.
